(19) United States
(12) Patent Application Publication
(10) Pub. No.: US 2025/0067981 A1
(43) Pub. Date: Feb. 27, 2025

(54) BINOCULAR DISPLAY SYSTEM FOR AN EYEWEAR DISPLAY

(71) Applicant: GOOGLE LLC, Mountain View, CA (US)

(72) Inventors: Joseph Daniel Lowney, Tucson, AZ (US); Shreyas Potnis, Kitchener (CA)

(21) Appl. No.: 18/811,186

(22) Filed: Aug. 21, 2024

Related U.S. Application Data
(60) Provisional application No. 63/533,776, filed on Aug. 21, 2023.

(51) Int. Cl. G02B 27/01

(52) U.S. Cl. CPC G02B 27/0172; G02B 2027/0178

(57) ABSTRACT

An eyewear display includes a first waveguide incorporated into one lens of the eyewear display and a second waveguide incorporated into the other lens of the eyewear display. The first waveguide includes a first incoupler, and the second waveguide includes a second incoupler. The eyewear display also includes a light engine with a switchable panel to alternate between directing display light to the first incoupler and directing display light to the second incoupler.

### BACKGROUND

In a virtual reality (VR), augmented reality (AR), or mixed reality (MR) eyewear display, display light from an image source is coupled into a light guide substrate, generally referred to as a waveguide, by an input optical coupling (referred to as an “incoupler”) which can be formed on a surface of the waveguide or disposed within the waveguide. Once the display light beams have been coupled into the waveguide, the display light beams are “guided” through the waveguide, typically by multiple instances of total internal reflection (TIR), to then be directed out of the waveguide by an output optical coupling (referred to as an “outcoupler”). The display light beams projected from the waveguide by the outcoupler overlap at an eye relief distance from the waveguide forming an exit pupil within which a virtual image generated by the image source can be viewed by the user of the eyewear display.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example of a binocular eyewear display in accordance with various embodiments.

FIG. 2 shows an example of a projection system for one lens of an eyewear display, such as one corresponding to the binocular eyewear display of FIG. 1, in accordance with various embodiments.

FIG. 3 shows an example of a portion of a binocular eyewear display, such as one corresponding to the binocular eyewear display of FIG. 1, in accordance with various embodiments.

FIG. 4 shows an example of a front view of a binocular waveguide architecture in accordance with various embodiments.

FIG. 5 shows a top view of the binocular waveguide architecture illustrated in FIG. 4 along with a light engine in accordance with various embodiments.

FIG. 6 shows an example of a 4f imaging system in a binocular display system with a single light engine in accordance with various embodiments.

FIG. 7 shows an example of a folded light path binocular display system with a reflective panel and a beam splitter cube in accordance with various embodiments.

FIGS. 8 and 9 show a top view and a front view, respectively, of an example of a binocular display system in accordance with various embodiments.

### DETAILED DESCRIPTION

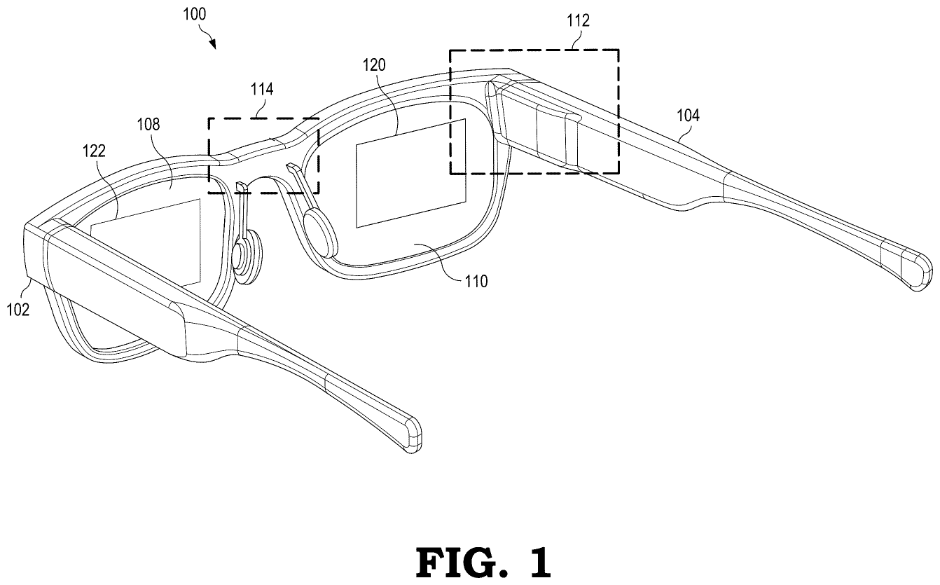

Some eyewear displays include a binocular display system that allows for the observation of virtual images on both lenses of the eyewear display. Conventional binocular eye displays typically include two light engines. The first light engine emits light that is used to generate an image to be displayed at one lens of the eyewear display, and the second light engine emits light that is used to generate an image to be displayed at the other lens of the eyewear display. Including two light engines increases the mass and volume occupied by the light engine components in the eyewear display, which typically has a limited form factor. FIGS. 1-9 provide techniques that reduce the mass and volume of the optical components associated with implementing a binocular display system in an eyewear display.

To illustrate, in some embodiments, an eyewear display includes a light engine that uses a panel that is switchable to couple display light into either the left lens or the right lens of the eyewear display. The left lens includes a first waveguide with a first incoupler and the right lens includes a second waveguide with a second incoupler. In some embodiments, the switching takes place at a rate that is higher than is detectable by the human visual system (e.g., at about 60 Hz or faster), such that the images presented at the different lenses appear to be displayed concurrently. Thus, the eyewear display architecture presented herein provides a binocular display system that is driven with a single light engine that is shared by both incouplers. This reduces the volume and size of the light engine components within the limited form factor of the eyewear display.

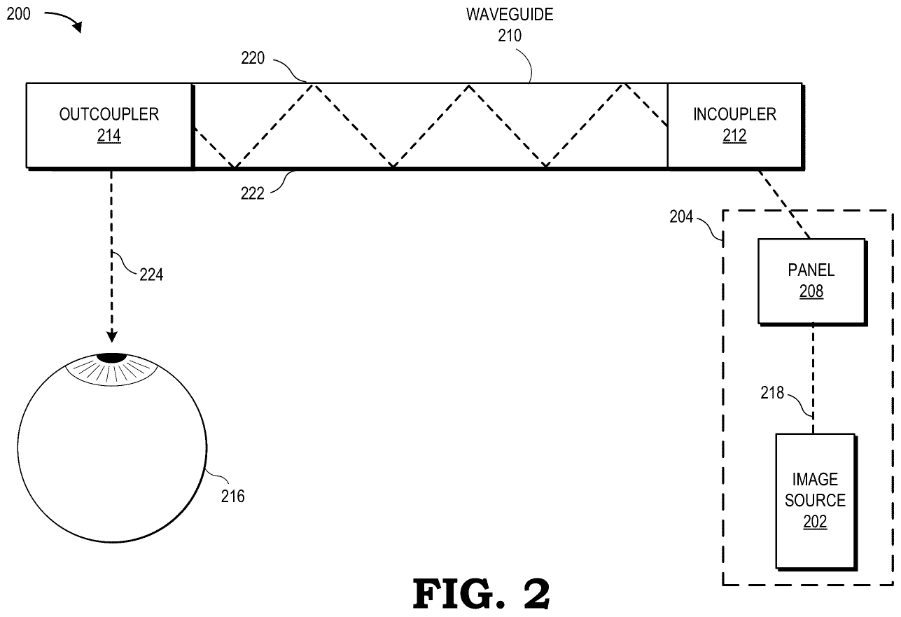

FIG. 1 shows an example eyewear display 100 in accordance with various embodiments. The eyewear display 100 (also referred to as a wearable heads up display (WHUD), head-mounted display (HMD), near-eye display, or the like) has a support structure 102 that includes an arm 104 including a temple region 112 at an interface with a lens rim of the eyewear display 100 and a nose bridge region 114 joining the two lens rims of the eyewear display 102. In some embodiments, the node bridge region 114 houses a micro-display projection system configured to project images toward the eye of a user, such that the user perceives the projected images as being displayed in a field of view (FOV) area 120, 122 of a display at one or both of lens elements 108, 110. In the depicted embodiment, the support structure 102 of the eyewear display 100 is configured to be worn on the head of a user and has a general shape and appearance (i.e., “form factor”) of an eyeglasses frame. The support structure 102 contains or otherwise includes various components to facilitate the projection of such images toward the eye of the user, such as an image source and a waveguide (shown in FIG. 2, for example). In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a WiFi interface, and the like. Further, in some embodiments, the support structure 102 includes one or more batteries or other portable power sources for supplying power to the electrical components of the eyewear display 100. In some embodiments, some or all of these components of the eyewear display 100 are fully or partially contained within an inner volume of support structure 102, such as within the arm 104 in region 112 of the support structure 102. It should be noted that while an example form factor is depicted, it will be appreciated that in other embodiments the eyewear display 100 may have a different shape and appearance from the eyeglasses frame depicted in FIG. 1.

One or both of the lens elements 108, 110 (also referred to as lenses, for short) are used by the eyewear display 100 to provide an area in which rendered graphical content can be superimposed over or otherwise provided in conjunction with a real-world view as perceived by the user through the lens elements 108, 110. In some embodiments, one or both of lens elements 108, 110 serve as optical combiners that combine environmental light (also referred to as ambient light) from outside of the eyewear display 100 and light emitted from the image source in the eyewear display 100. For example, light used to form a perceptible image or series of images may be projected by the image source of the eyewear display 100 onto the eye of the user via a series of optical elements, such as a waveguide formed at least partially in the corresponding lens element, one or more scan mirrors, one or more optical relays (also referred to as projection optics), and/or one or more prisms. In some embodiments, the image source is configured to emit light having different wavelength ranges (e.g., different colors) and/or different polarization states (e.g., s-polarized light, p-polarized light, or a combination thereof). One or both of the lens elements 108, 110 thus includes at least a portion of a waveguide that routes display light received by the incoupler of the waveguide to an outcoupler of the waveguide, which outputs the display light toward an eye of a user of the eyewear display 100. The display light is modulated and projected onto the eye of the user such that the user perceives the display light as an image in FOV area 120, 122. In addition, each of the lens elements 108, 110 is sufficiently transparent to allow a user to see through the lens elements to provide a field of view of the user's real-world environment such that the image appears superimposed over at least a portion of the real-world environment.

In some embodiments, the image source is a digital light processing-based projector, a scanning laser projector, a liquid crystal on silicon (LCoS) display, or any combination of a modulative light source such as a laser or one or more light-emitting diodes (LEDs), such as a micro-LED, or organic light-emitting diodes (OLEDs) located in nose bridge region 114. In some embodiments, the image source includes multiple laser diodes (e.g., a red laser diode, a green laser diode, and/or a blue laser diode) and at least one scan mirror (e.g., two one-dimensional scan mirrors, which may be microelectromechanical system (MEMS)-based or piezo-based). The image source is communicatively coupled to the controller (not shown) and a non-transitory processor-readable storage medium or memory storing processor-executable instructions and other data that, when executed by the controller, cause the controller to control the operation of the image source. In some embodiments, the controller controls a scan area size and scan area location for the image source and is communicatively coupled to the image source (not shown) that generates content to be displayed at the eyewear display 100. The image source scans light over a variable area, designated the FOV area 120, 122 of the eyewear display 100. Generally, it is desirable for a display to have a wide FOV area 120, 122 to accommodate the outcoupling of light across a wide range of angles. In some embodiments, the controller also controls the switching aspects of the switchable panel as described herein.

As previously mentioned, in some embodiments the eyewear display 100 is a binocular eyewear display, and waveguides are integrated into both lens elements 108, 110. In some embodiments, each waveguide includes a single waveguide substrate and in other embodiments, each waveguide includes multiple waveguide substrates stacked on top of one another (referred to as a waveguide stack). Each of the waveguides integrated into lens elements 108, 110 includes an incoupler in the nose bridge region 114. The incouplers are positioned within the lens elements 108, 110 adjacent to the nose bridge region 114. The image source (which in some cases includes one or more light emitting elements such as one or more LEDs) is positioned in the nose bridge region 114 and emits light such that an incoupler of the first waveguide integrated into one of lens element 108, 110 receives light from the image source during a first time period and the second incoupler of the second waveguide integrated into the other one of the lens elements 108, 110 receives light from the image source during a second time period different than the first time period. For example, in some embodiments, the image source is configured to generate display light to project a first image to be directed to the first waveguide and generate display light to project a second image to be directed to the second waveguide. A switchable panel in the optical path between the image source and each of the incouplers in the lens elements 108, 110 is switchable to direct light toward the incoupler of the lens element 108 during a first time period and to direct light toward the incoupler of the other lens element 110 during a second time period. In some cases, the first image and the second image are different images and in other cases they are the same image. In some embodiments, the controller controls the switchable panel to switch between directing light to each of the incouplers of the lens elements 108, 110 at a rate that is imperceptible to the human eye (e.g., faster than 60 Hz) so that the first image and the second image appear to the user as being displayed at the same time.

FIG. 2 shows an example of a projection system 200 that projects images onto an eye 216 of a user in accordance with various embodiments. The projection system 200, which may be implemented in the eyewear display 100 in FIG. 1, includes a light engine 204 including an image source 202 and a switchable panel 208. The projection system 200 also includes a waveguide 210 that is integrated into one of the two lens elements 108, 110 of FIG. 1. The waveguide 210 includes an incoupler 212 and an outcoupler 214, with the outcoupler 214 being optically aligned with an eye 216 of a user. For example, the outcoupler 214 substantially overlaps or corresponds with one of the FOV areas 120, 122 shown in FIG. 1. For purposes of clarity, FIG. 2 illustrates the projection system 200 with respect to propagating display light from the image source 202 to one eye 216 of the user. In some embodiments, the projection system 200 includes a similar configuration to propagate display light from the same light engine 204 through a second waveguide integrated into another one of the lens elements 108, 110 of FIG. 1 to a second eye of the user (not shown in FIG. 2).

In some embodiments, the image source 202 (such as a micro-LED display) includes one or more light sources configured to generate and project display light 218 (e.g., visible light such as red, blue, and green light and, in some embodiments, non-visible light such as infrared light). In some embodiments, the image source 202 is coupled to a driver or other controller (not shown), which controls the timing of emission of display light from the light sources of the image source 202 in accordance with instructions received by the controller or driver from a computer processor coupled thereto to modulate the display light 218 to be perceived as images when output to the retina of an eye 216 of a user. For example, during operation of the projection system 200, one or more beams of display light 218 are output by the light source(s) of the image source 202 and then directed into the waveguide 210 before being directed to the eye 216 of the user. The image source 202 modulates the respective intensities of the light beams so that the combined light reflects a series of pixels of an image, with the particular intensity of each light beam at any given point in time contributing to the amount of corresponding color content and brightness in the pixel being represented by the combined light at that time. In some embodiments, the controller also controls the switching aspects of the switchable panel 208 as described herein. For example, the controller is configured to transmit a control signal that electronically switches the switchable panel 208 between a first state to direct light to the incoupler 212 and a second state to direct light to another incoupler (not shown in FIG. 2).

In some embodiments, the image source 202 projects the display light 218 through the light engine 204 to a switchable panel 208. The switchable panel 208 is, for example, a transmissive panel in some embodiments and a reflective panel in other embodiments. Examples of a transmissive panel include a liquid crystal display (LCD) panel or the like. Examples of a reflective panel include a liquid crystal on silicon (LCoS) panel, a digital micromirror display (DMD), or the like. In some embodiments, the light engine 204 includes additional optical elements such as lenses (e.g., spherical, aspheric, parabolic, and/or freeform lenses), prisms, mirrors, and the like to introduce a convergence to the light 218 in the first dimension to an exit pupil that coincides with the incoupler 212. Herein, an “exit pupil” in an optical system refers to the location along the optical path where beams of light intersect. For example, the width (i.e., smallest dimension) of a given exit pupil approximately corresponds to the diameter of the light corresponding to that exit pupil. Accordingly, the exit pupil can be considered a “virtual aperture.” According to various embodiments, the light engine 204 includes one or more collimation, spherical, aspheric, parabolic, and/or freeform lenses that shape and direct the light, together with switchable panel 208, such that the light is directed to the incoupler 212 of the waveguide 210.

As shown in FIG. 2, the waveguide 210 of the projection system 200 includes the incoupler 212 and the outcoupler 214. The term “waveguide,” as used herein, will be understood to mean a combiner using one or more of total internal reflection (TIR), specialized filters, or reflective surfaces, to transfer light from an incoupler (such as incoupler 212) to an outcoupler (such as the outcoupler 214). In some display applications, the light is a collimated image, and the waveguide 210 transfers and replicates the collimated image to the eye. In general, the terms “incoupler” and “outcoupler” (as well as “exit pupil expander”) will be understood to refer to any type of optical grating structure, including, but not limited to, diffraction gratings, holograms, holographic optical elements (e.g., optical elements using one or more holograms), volume diffraction gratings, volume holograms, surface relief diffraction gratings, and/or surface relief holograms. In some embodiments, a given incoupler or outcoupler is configured as a transmissive grating (e.g., a transmissive diffraction grating or a transmissive holographic grating) that causes the incoupler or outcoupler to transmit light and to apply designed optical function(s) to the light during the transmission. In some embodiments, a given incoupler or outcoupler is a reflective grating (e.g., a reflective diffraction grating or a reflective holographic grating) that causes the incoupler or outcoupler to reflect light and to apply designed optical function(s) to the light during the reflection. In other embodiments, a given incoupler or outcoupler includes one or more reflective mirror facets. For example, the incoupler or the outcoupler includes a set of partially reflective mirror facets with the same or with different reflection to transmission ratios.

The incoupler 212 is configured to receive the display light 218 and direct the display light 218 into the waveguide 210. In some embodiments, the “incoupler region” is defined as the region of the waveguide 210 between the first edge and the second edge. Similarly, the “outcoupler region” is defined as the region of the waveguide occupied by the outcoupler 214. In the present example, the light 218 received at the incoupler 212 is relayed to the outcoupler 214 via the waveguide 210 using TIR. A portion of the light 218 is then output to the eye 216 of a user via the outcoupler 214. Also, in some embodiments, an exit pupil expander (not shown in FIG. 2), such as a fold grating, is arranged in an intermediate stage between incoupler 212 and outcoupler 214 to receive light that is coupled into waveguide 210 by the incoupler 212, expand the light in one dimension, and redirect the light towards the outcoupler 214, where the outcoupler 214 then couples the light out of waveguide 210. In some embodiments, the exit pupil expander and the outcoupler 214 are integrated into a common component. As described above, in some embodiments the waveguide 210 is implemented in an optical combiner as part of a lens, such as one of the lens elements 108, 110 of FIG. 1.

The waveguide 210 further includes two major surfaces 220 and 222, with major surface 220 being world-side (i.e., the surface farthest from the user) and major surface 222 being eye-side (i.e., the surface closest to the user). In some embodiments, the waveguide 210 is between a world-side lens and an eye-side lens, which form lens elements 108, 110 shown in FIG. 1, for example. In some embodiments, the incoupler 212 and the outcoupler 214 are located, at least partially, at major surface 220. In another embodiment, the incoupler 212 and the outcoupler 214 are located, at least partially, at major surface 222. In further embodiments, the incoupler 212 is located at one of the major surfaces, while the outcoupler 214 is located at the other of the major surfaces.

In some embodiments, the switchable panel 208 is configured to alternate between directing light from the image source 202 to the incoupler 212 of the waveguide 210 integrated into one lens element (such as lens element 108 of FIG. 1) and from the image source 202 to the incoupler of another waveguide (not shown in FIG. 2) that is integrated into the other lens element (such as lens element 110 of FIG. 1). That is, the switchable panel 208 is electronically switchable by a controller or processor (not shown in FIG. 2) from a first state to direct light from the image source 202 to the incoupler 212 during a first time period and to a second state to direct light from the image source 202 to the other incoupler during a second time period and vice versa. In some cases, the controller controls the switchable panel 208 to switch between the first state and the second state at a rate faster than is perceptible by the human eye, e.g., faster than 60 Hz.

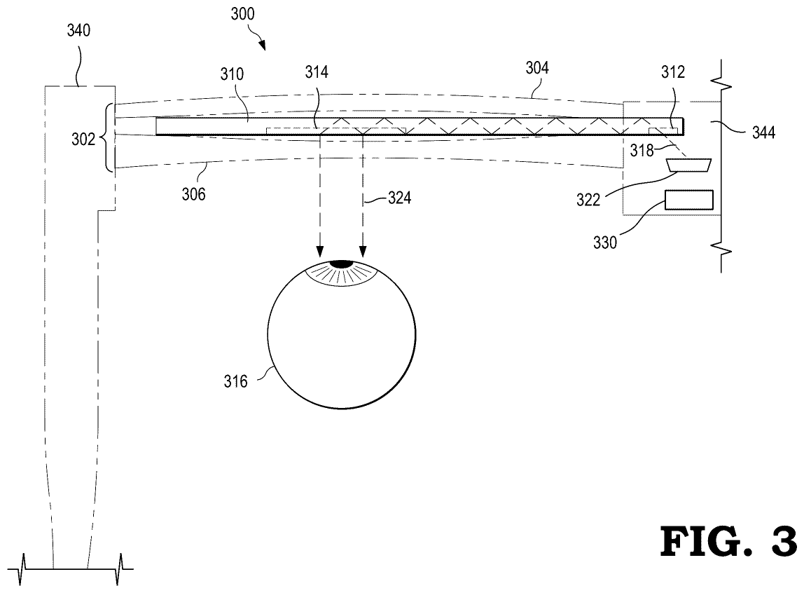

FIG. 3 shows an example of a portion of an eyewear display 300 in accordance with various embodiments. In some embodiments, the eyewear display 300 corresponds to the eyewear display 100 of FIG. 1 and includes the projection system 200 of FIG. 2 or components thereof.

As shown in FIG. 3, the eyewear display 300 includes a light engine 322 (such as one corresponding with the light engine 204 of FIG. 2) in a nose bridge region 344 (e.g., corresponding with nose bridge region 114 of FIG. 1) of the eyewear display 300. The eyewear display 300 also includes a controller 330 to control various components of the eyewear display such as the image source (e.g., light emitting elements) and the switchable panel as described herein. In some aspects, the controller 330 is positioned in the arm 340 of the eyewear display. The light engine 322 emits display light 318 toward the incoupler 312 of a waveguide 310 that is integrated into lens 302 (e.g., corresponding to one of lens elements 108, 110 of FIG. 1). The arm 330 of the portion of the eyewear display 300 is also illustrated for clarity purposes.

The eyewear display 300 includes a lens 302 that serves as an optical combiner. In some embodiments, the lens 302 corresponds to one of lens elements 108, 110 of FIG. 1. The lens 302 is held in one of the two lens rims of the eyewear display 300. The lens 302 includes a lens stack including a first lens layer 304, a second lens layer 306, and a waveguide 310 disposed between the first lens layer 304 and the second lens layer 306. As illustrated, the first lens layer 304 is a world-side lens layer and the second lens 306 is an eye-side lens layer. In some embodiments, the waveguide 310 includes an incoupler 312 to incouple display light 318 into the waveguide 310 such that the display light is propagated within the waveguide 310 via various instances of TIR. The waveguide 310 also includes an outcoupler 314 to outcouple the display light 324 toward an eye 216 of the user. Thus, the eyewear display 300 includes a lens 302 serving as an optical combiner that is held in place by a corresponding lens rim of the eyewear display 300. Light exiting through the outcoupler 314 travels through the second lens 306. In use, the light 324 exiting second lens 306 enters the pupil of an eye 316 of a user wearing the eyewear display 300, causing the user to perceive a displayed image carried by the light output by the light engine 322. For example, the user perceives the displayed image over an FOV area such as one of FOV areas 120, 122 of FIG. 1. The different layers of the lens 302 are substantially transparent, such that light from real-world scenes corresponding to the environment around the eyewear display 300 passes through the first lens layer 304, the second lens layer 306, and the waveguide 310 to the eye 316 of the user. In this way, images or other graphical content output by the image projection system 300 are combined (e.g., overlayed) with real-world images of the user's environment when projected onto the eye 316 of the user to provide an augmented reality (AR) or mixed reality (MR) experience to the user. Although not shown in the depicted example, in some embodiments additional optical elements are included in any of the optical paths between the light engine 322 and the incoupler 312, in between the incoupler 312 and the outcoupler 314, and/or in between the outcoupler 314 and the eye 316 of the user (e.g., in order to shape the display light for viewing by the eye 316 of the user).

In some embodiments, a similar configuration is implemented at the other one of the lenses (not shown) of the eyewear display 300 sharing the light engine 322. For example, a second waveguide with a corresponding incoupler positioned in the nose bridge region 344. In some embodiments, one or more optical components (not shown) such as one or more lenses, a switchable panel (e.g., a transmissive panel or a reflective panel), or a beam splitter cube direct light from the light engine 322 to the incoupler in the second waveguide in alternating fashion along with the light 318 that is directed to incoupler 312 in waveguide 310.

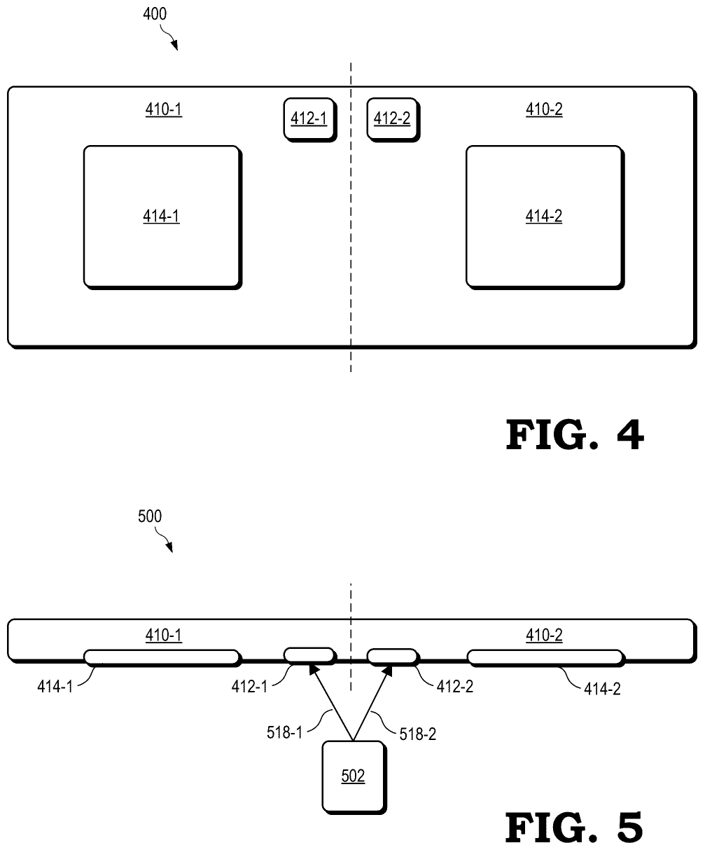

FIG. 4 shows an example of a front view 400 of a binocular waveguide architecture in accordance with various embodiments. As shown, the binocular waveguide architecture 400 includes a first waveguide 410-1 and a second waveguide 410-2. The first waveguide 410-1 is incorporated into a first lens (e.g., a left lens) of an eyewear display such as eyewear display 100 of FIG. 1, and the second waveguide 410-2 is incorporated into a second lens (e.g., a right lens) of the eyewear display. The first waveguide 410-1 includes a first incoupler 412-1 and a first outcoupler 414-1. The second waveguide 410-2 includes a second incoupler 412-2 and a second outcoupler 414-2. In some embodiments, the first waveguide 410-1 and the second waveguide 410-2 are mechanically or laser singulated along the dashed line shown in FIG. 4 into separate waveguides to be incorporated into the separate lenses of the eyewear display. In some embodiments, the waveguides 410-1 and 410-2 are not singulated into separate waveguides. In this case, a single, larger waveguide (including both 410-1 and 410-2) is integrated across the lens or lenses of the eyewear display to direct light to both eyes of the user. For example, the single, larger waveguide includes a first portion corresponding to first waveguide 410-1 that directs light to one eye of the user via first incoupler 412-1 and first outcoupler 414-1 and a second portion corresponding to second waveguide 410-2 that directs light to the other eye of the user via second incoupler 412-2 and second outcoupler 414-2. In some embodiments, the waveguides 410 are partially curved and/or rotated to fit the form factor of the eyewear display.

FIG. 5 shows a top view 500 of the binocular waveguide architecture illustrated in FIG. 4 along with a light engine 502 in accordance with various embodiments. In some embodiments, the light engine 502 includes an image source such as image source 202 of FIG. 2 and optical components for propagating light from the image source to each of the incouplers 412. For example, in some embodiments, the light engine 502 includes a switchable panel for directing display light 518-1 to the first incoupler 412-1 during a first time period and for directing display light 518-2 to the second incoupler 412-2 during a second time period. In some embodiments, display light 518-1 and display light 518-2 convey the same image, i.e., the same image is observable at each lens of the eyewear display. In other embodiments, display light 518-1 and display light 518-2 convey different images, i.e., a different image is observable at each lens of the eyewear display. In some embodiments, the light engine 502 is configured to switch between transmitting display light 518-1 to the first incoupler 412-1 and transmitting display light 518-2 to the second incoupler 412-2 at a rate faster than is observable by the human eye, e.g., faster than 60 Hz.

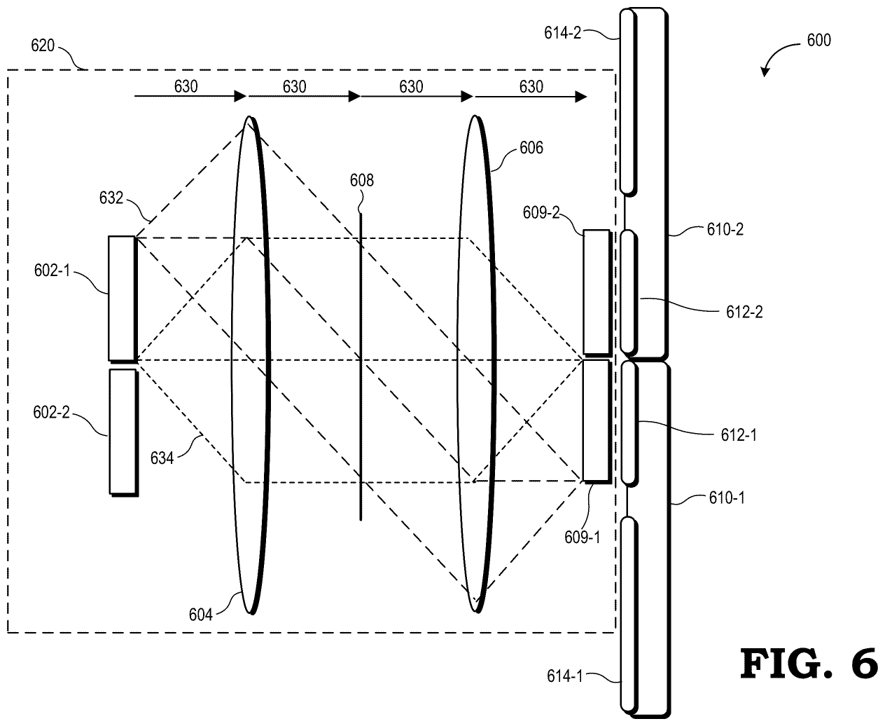

FIG. 6 shows an example of a binocular display system 600 that is configured to generate images at two lens elements of an eyewear display via a single light engine in accordance with some embodiments. The binocular display system 600 includes two waveguides 610-1, 610-2 and a light engine 620.

The first waveguide 610-1 is integrated into one lens of an eyewear display (e.g., into lens element 108 of the eyewear display 100 of FIG. 1) and the second waveguide 610-2 is integrated into another lens of the eyewear display (e.g., into lens element 110 of the eyewear display of FIG. 1). Each of the waveguides 610-1, 610-2 includes a respective incoupler 612-1, 612-2 to incouple light from the light engine 620 and a respective outcoupler 614-1, 614-2 to outcouple light from the waveguide to a respective eye of a user.

In the illustrated embodiment, the light engine 620 includes two light emitting elements such as two LEDs 602-1, 602-2 as an image source. The first LED 602-1 is configured to emit light that is guided by the other optical components of the light engine 620 to the incoupler 612-1 of the first waveguide 610-1. For example, the first LED 602-1 emits light beams 632 (indicated by the longer dashed lines, one labeled for clarity purposes) from the top side of the first LED 602-1 and light beams 634 (indicated by the shorter dashed lines, one labeled for clarity purposes) from the bottom side of the first LED 602-1. The light engine 602 guides the light beams 632 through the first lens 604, a transmissive switchable panel 608 (e.g., an LCD panel), and a second lens 606 to form a first exit pupil 609-1 that is coupled into the incoupler 612-1 of the first waveguide 610-1. Similarly, the second LED 602-2 is configured to emit light that is guided by the other optical components (e.g., the first lens 604, the transmissive switchable panel 608, and the second lens 606) of the light engine 620 to form a second exit pupil 609-2 that is coupled into the incoupler 612-2 of the second waveguide 610-2 (light beams from the second LED 602-2 not shown for clarity purposes).

In some embodiments, the transmissive switchable panel 608 is switchable between a first state to allow light beams from the first LED 602-1 to be directed to the incoupler 612-1 of the first waveguide 610-1 (as shown in the illustrated embodiment) and a second state to allow light beams from the second LED 602-2 to be directed to the incoupler 612-2 of the second waveguide 610-2 (not shown for clarity purposes). That is, the transmissive switchable panel 608 is configured to receive an electronic control signal (e.g., from a controller or the like) and alternate between a first state to direct light to the incoupler 612-1 of the first waveguide 610-1 and a second state to direct light to the incoupler 612-2 of the second waveguide 612-2. For example, in the first state, a first subset of sections of the transmissive switchable panel 608 is controlled to transmit light to the incoupler 612-1 of the first waveguide 610-1 and a second subset of sections of the transmissive switchable panel 608 is controlled to block light to the incoupler 612-2 of the second waveguide 610-1. In the second state, the first subset of sections of the transmissive switchable panel 608 is controlled to block light to the incoupler 612-1 of the first waveguide 610-1 and the second subset of sections of the transmissive switchable panel 608 is controlled to transmit light to the incoupler 612-2 of the second waveguide 610-1. In this manner, the transmissive switchable panel 608 includes a plurality of sections, where each section is controllable between a transmissive state and a non-transmissive state (e.g., a light blocking state) to selectively control the light that passes through the transmissive switchable panel 608 and toward one of the two incouplers 610. In some cases, the transmissive switchable panel 608 is switchable between the first and second states at a rate faster than is perceptible by the human eye, e.g., faster than 60 Hz. That is, the light engine 620 of the binocular eyewear display 600 is a sequential imaging system in which light is transmitted to the left eye and to the right eye from an image source in a sequential manner (i.e., light from the image source is directed to the first incoupler and to the second incoupler in alternating fashion). In this manner, the binocular display system 600 is configured to transmit light to each incoupler 612 of the two waveguides 610-1, 610-2 utilizing a shared light engine 620. This reduces the size and weight of the optical components necessary to implement a binocular display system within the constrained form factor of an eyewear display.

In the illustrated embodiment, the light engine 620 includes optical components (e.g., the two lenses 604, 606 and the transmissive switchable panel 608) to implement a 4f imaging system. That is, the two lenses 604, 606 and the transmissive switchable panel 608 are separated by a common distance 630 that coincides with a focal length of the two lenses 604, 606. In the illustrated embodiment, the total track length of the 4f imaging system is 4f and has a magnification of −1. In some embodiments, other types of imaging systems can be used in place of the 4f imaging system illustrated in FIG. 6. For example, the illustrated 4f imaging system has a 1:1 magnification. In some embodiments, the magnification can be adjusted to suit eyewear display system requirements. In addition, in some embodiments, the display system includes more complex individual lenses to minimize optical aberrations and improve the overall image quality and uniformity.

In addition, in the illustrated embodiment, the binocular display system 600 uses two waveguides 610-1, 610-2 to direct light to the left eye and the right eye. In other embodiments, the two waveguides 610-1, 610-2 are combined into a single waveguide substrate while still including the separate incouplers and outcouplers for each eye.

In FIG. 6, the transmissive panel (e.g., an LCD panel) 608 is positioned within the light engine 620. In other embodiments, a reflective panel such as a Liquid Crystal on Silicon (LCoS) panel or a digital micromirror display (DMD) is used to minimize the volume occupied by the light engine. For example, in embodiments using a reflective panel, the general principles described above are similarly applicable, but the imaging system may occupy less space by using a beam splitter cube or the like.

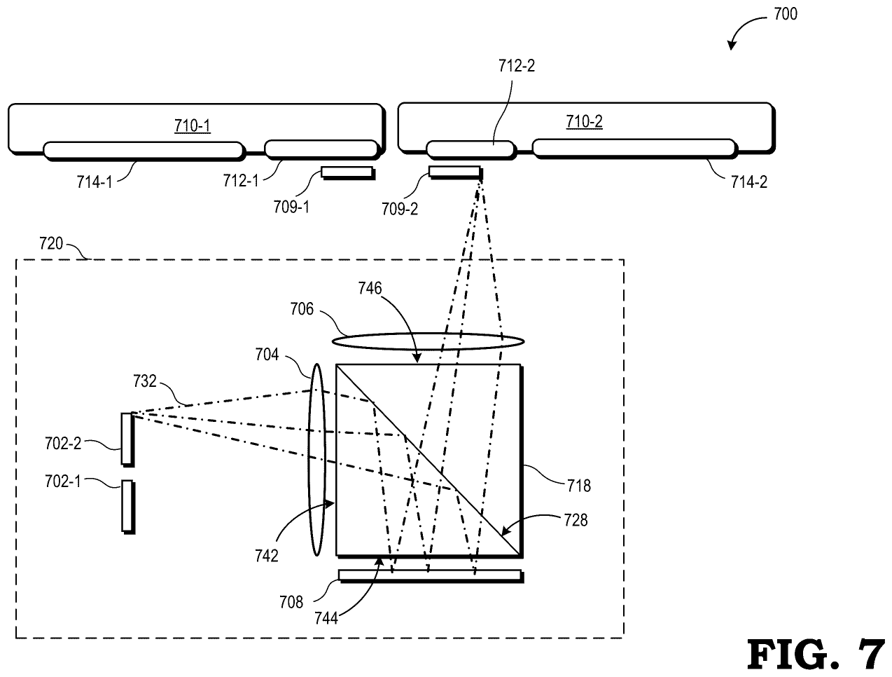

FIG. 7 shows an example of a folded light path binocular display system 700 that is configured to generate images at two lens elements of an eyewear display via a single light engine in accordance with some embodiments. The binocular display system 700 includes two waveguides 710-1, 710-2 and a light engine 720. In the illustrated embodiment, the light engine 720 includes two lenses 704, 706, a beam splitter cube 718 with a selectively reflective surface 728, and a reflective panel 708 (e.g., an LCoS panel or a DMD panel)

Similar to the waveguide described in FIG. 6, the first waveguide 710-1 is integrated into one lens of an eyewear display (e.g., into lens element 108 of the eyewear display 100 of FIG. 1) and the second waveguide 710-2 is integrated into another lens of the eyewear display (e.g., into lens element 110 of the eyewear display of FIG. 1). Each of the waveguides 710-1, 710-2 includes a respective incoupler 712-1, 712-2 to incouple light from the light engine 720 and a respective outcoupler 714-1, 714-2 to outcouple light from the waveguide to a respective eye of a user.

In the illustrated embodiment, the light engine 720 includes two light emitting elements such as two LEDs 702-1, 702-2 as an image source. The first LED 702-1 is configured to emit light that is guided by the other optical components of the light engine 720 to form an exit pupil 709-1 on the incoupler 712-1 of the first waveguide 710-1. The second LED 702-2 is configured to emit light that is guided by the other optical components of the light engine 720 to form an exit pupil 709-2 on the incoupler 712-2 of the second waveguide 710-2. For example, the second LED 702-2 emits light beams 732 (one labeled for clarity purposes). The light beams 732 pass through the first lens 704 and enter the beam splitter cube 718 through a first side 742 of the beam splitter cube 718. The light beams 732 reflect off a selectively reflective surface 728 within the beam splitter cube 718 at a first incident angle and exit the beam splitter cube 718 via a second side 744 of the beam splitter cube 718 to reflect off the reflective panel 708. After reflecting from the reflective panel 708, the light beams 732 pass through the second side 744 of the beam splitter cube 718 and through the selectively reflective surface 728 at a second incident angle that is different from the first incident angle. After exiting the beam splitter cube 718 via a third side 746 of the beam splitter cube 718 opposite of the second side 744, the light beams pass through the second lens 706. The second lens 706 directs the light beams to form an exit pupil 709-2 that coincides with the incoupler 712-2 of the second waveguide 710-2. Similarly, the first LED 702-1 is configured to emit light that is guided by the other optical components (e.g., the first lens 704, the beam splitter cube 718, the reflective panel 708, and the second lens 706) of the light engine 720 to form a first exit pupil 709-1 that is coupled into the incoupler 712-1 of the first waveguide 710-1 (light beams from the first LED 702-1 not shown for clarity purposes). The reflective panel 708 is switchable to direct light to each waveguide in alternating fashion at a rate that is not perceptible by the human visual system. In some embodiments, the beam splitter cube 718 is a polarizing beam splitter cube.

In some embodiments, the reflective panel 708 is configured to receive an electronic control signal (e.g., from a controller or the like) and alternate between a first state to direct light to the incoupler 712-1 of the first waveguide 710-1 and a second state to direct light to the incoupler 712-2 of the second waveguide 712-2. For example, in the first state, a first subset of sections of the reflective panel 708 is controlled to reflect light to the incoupler 712-1 of the first waveguide 710-1 and a second subset of sections of the reflective panel 708 is controlled to not reflect light to the incoupler 712-2 of the second waveguide 710-1. In the second state, the first subset of sections of the reflective panel 708 is controlled to not reflect light to the incoupler 712-1 of the first waveguide 710-1 and the second subset of sections of the reflective panel 708 is controlled to reflect light to the incoupler 712-2 of the second waveguide 710-1. In this manner, the reflective panel 708 includes a plurality of sections, where each section is controllable between a reflective state to direct light to the corresponding incoupler and another state (e.g., a light transmissive state or a reflective state to direct light away from the corresponding incoupler) that does not reflect light toward the corresponding incoupler.

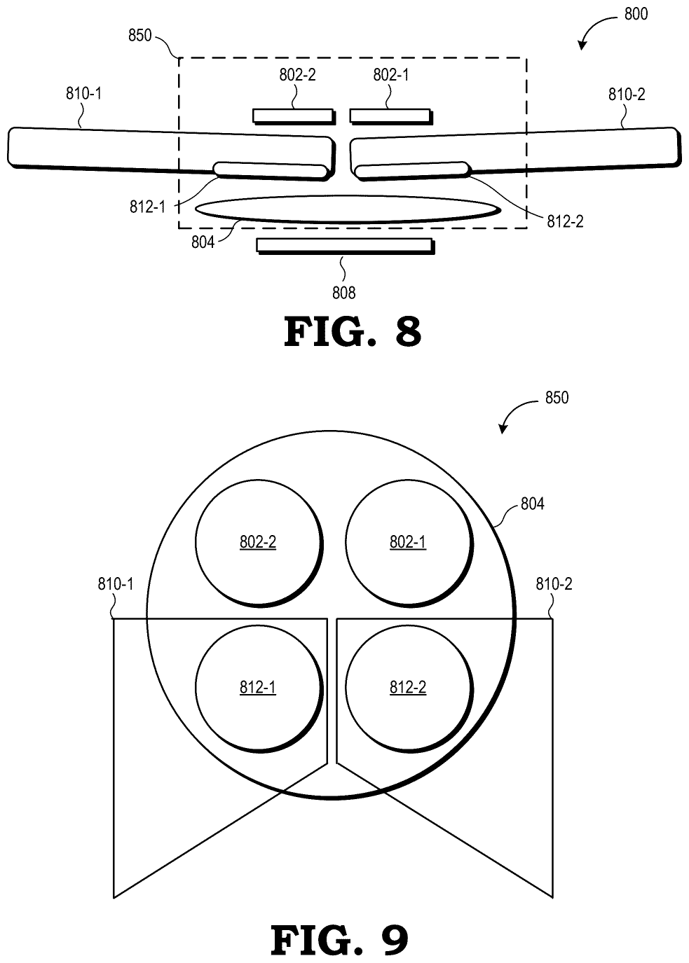

FIG. 8 shows a top view of another embodiment of a portion of a binocular display system 800 that is configured to generate images at two lens elements of an eyewear display via a single light engine in accordance with some embodiments. FIG. 9 shows a front view of a portion 850 of the binocular display system 800 of FIG. 8. The binocular display system 800 includes two waveguides 810-1, 810-2 and a light engine that includes components on both sides of the waveguides 810.

The first waveguide 810-1 is integrated into one lens of an eyewear display (e.g., into lens element 108 of the eyewear display 100 of FIG. 1) and the second waveguide 810-2 is integrated into another lens of the eyewear display (e.g., into lens element 110 of the eyewear display of FIG. 1). Each of the waveguides 810-1, 810-2 includes a respective incoupler 812-1, 812-2 to incouple light from the light engine 620 and a respective outcoupler (not shown for clarity purposes) to outcouple light from the waveguide to a respective eye of a user.

In the illustrated embodiment, the light engine of the binocular display system 800 includes two light emitting elements such as two LEDs 802-1, 802-2 as an image source. The first LED 802-1 is configured to emit light that is guided by the other optical components of the binocular display system 800 to the incoupler 812-1 of the first waveguide 810-1. The second LED 802-2 is configured to emit light that is guided by the other optical components of the binocular display system 800 to the incoupler 812-2 of the second waveguide 810-2. For example, the first LED 802-1 is configured to emit light over the second waveguide 810-2 and through the lens 804. The light passes through the lens 804 and is directed toward the reflective panel 808. The reflective panel 808 reflects the light back through the lens 804, which redirects the light toward the incoupler 812-1 on the first waveguide 810-1. Similarly, the second LED 802-2 is configured to emit light over the first waveguide 810-1 and through the lens 804. The light passes through the lens 804 and is directed toward the reflective panel 808. The reflective panel 808 reflects the light back through the lens 804, which redirects the light toward the incoupler 812-2 on the first waveguide 810-2.

In some embodiments, the reflective panel is switchable so as to alternate between reflecting light received from first LED 802-1 to the incoupler 812-1 on the first waveguide 810-1 and reflecting light received from second LED 802-2 to the incoupler 812-2 on the second waveguide 810-2. In some embodiments, after reflecting off of the reflective panel 808, the light emitted from first LED 802-1 and the second LED 802-2 is reflected directly to the respective incoupler 812-1, 812-2 without passing through the lens 804 again (i.e., the lens 804 a different size so as to overlap with the LEDs 802-1, 802-2 and not with the incouplers 812-1, 812-2 shown in FIG. 9).

In some embodiments, the binocular display system architecture described herein does not rely on the polarization state of the light in order to direct the display light to the first waveguide or the second waveguide, i.e., to the left or right lens of the eyewear display. Instead, in some aspects, the binocular display system architecture presented herein relies on the temporal switching of the transmissive or reflective panel positioned in the optical path between the image source and the corresponding waveguides.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design shown herein, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An eyewear display comprising:
a first waveguide comprising a first incoupler;
a second waveguide comprising a second incoupler;
one or more light emitting elements; and
a switchable panel configured to alternate between directing light from at least one light emitting element of the one or more light emitting elements to the first incoupler and directing light from at least one light emitting element of the one or more light emitting elements to the second incoupler.

2. The eyewear display of claim 1, wherein the one or more light emitting elements comprise at least two light-emitting diodes (LEDs).

3. The eyewear display of claim 1, wherein the switchable panel is included in a light engine comprising the one or more light emitting elements.

4. The eyewear display of claim 3, wherein the switchable panel comprises a transmissive panel.

5. The eyewear display of claim 4, wherein the transmissive panel is a liquid crystal display (LCD) panel.

6. The eyewear display of claim 4, wherein the light engine further comprises:
a first lens configured to receive light from one of the one or more light emitting elements and direct light to the switchable panel; and
a second lens configured to receive light from the switchable panel and direct light to one of the first incoupler and the second incoupler.

7. The eyewear display of claim 4, wherein the switchable panel is electronically switchable at a rate of 60 Hz or faster.

8. The eyewear display of claim 3, wherein the switchable panel is a reflective panel.

9. The eyewear display of claim 8, wherein the reflective panel is one of a liquid crystal on silicon panel or a digital micromirror display panel.

10. The eyewear display of claim 8, wherein the light engine comprises two lenses and a beam splitter cube with a selectively reflective surface.

11. The eyewear display of claim 10, wherein the one or more light emitting elements emit light along an optical path that passes through a first lens of the two lenses, enters a first side of the beam splitter cube and reflects from the selectively reflective surface, exits the beam splitter cube from a second side, reflects from the reflective panel and enters the beam splitter cube at the second side, passes through the selectively reflective surface and a third side of the beam splitter cube opposite to the second side, and is directed through a second lens of the two lenses toward one of the first incoupler and the second incoupler.

12. The eyewear display of claim 8, wherein the light engine comprises one lens.

13. The eyewear display of claim 12, wherein the one or more light emitting elements emit light along an optical path that passes through the one lens and reflects from the reflective panel back through the one lens toward one of the first incoupler and the second incoupler.

14. An eyewear display comprising:
a waveguide comprising a first incoupler to incouple light toward a first outcoupler and a second incoupler to incouple light toward a second outcoupler;
one or more light emitting elements; and
a switchable panel configured to alternate between directing light from at least one light emitting element of the one or more light emitting elements to the first incoupler and directing light from at least one light emitting element of the one or more light emitting elements to the second incoupler.

15. The eyewear display of claim 14, wherein the one or more light emitting elements comprise at least two light-emitting diodes (LEDs).

16. The eyewear display of claim 14, wherein the switchable panel is included in a light engine comprising the one or more light emitting elements.

17. The eyewear display of claim 16, wherein the switchable panel comprises a transmissive panel, wherein the transmissive panel is a liquid crystal display (LCD) panel.

18. The eyewear display of claim 16, wherein the switchable panel comprises a reflective panel.

19. The eyewear display of claim 18, wherein the reflective panel is one of a liquid crystal on silicon panel or a digital micromirror display panel.

20. A method comprising:
emitting light from a first light emitting element of a light engine toward a first incoupler; and
emitting light from a second light emitting element of the light engine toward a second incoupler,
wherein the light engine comprises a switchable panel to alternate between directing light from the first light emitting element to the first incoupler and directing light from the second light emitting element to the second incoupler at a rate that is faster than 60 Hz.
